(19) United States
(12) Patent Application Publication
(10) Pub. No.: US 2018/0326636 A1
(43) Pub. Date: Nov. 15, 2018

(54) DEVICE FOR INJECTION MOLDING AND OVERMOLDING OBJECTS

(71) Applicant: SELECTRONA GMBH, Dippoldiswalde-Reinholdshain (DE)

(72) Inventor: KAY-UWE ZSCHOKE, DIPPOLDISWALDE (DE)

(73) Assignee: SELECTRONA GMBH, Dippoldiswalde-Reinholdshain (DE)

(21) Appl. No.: 15/774,680

(22) PCT Filed: Nov. 7, 2016
(86) PCT No.: PCT/DE2016/100525

§ 371 Date: May 9, 2018

(30) Foreign Application Priority Data
Nov. 9, 2015 (DE) 10 2015 119 235.7

(51) Int. Cl. B29C 45/37; B29C 45/14

(52) U.S. Cl. CPC B29C 45/376; B29C 45/14065; B29L 2031/749; B29C 45/14639; B29C 45/14819; B29C 45/1459

(57) ABSTRACT

A device for injection-molding and for overmolding objects has an upper element and a lower element, which surround a contiguous volume consisting of a filling space for holding the object and casting material and a sprue for holding casting material. The upper element is movable in relation to the lower element. A piston is arranged within the upper element in an integrated manner and is movable relative to the upper element. The position of the piston can be varied in accordance with a dimension of the object in an axial direction and the piston has a protrusion for changing a volume as filling amount balancing of the casting material within the sprue such that the device is filled with a constant amount of casting material irrespective of the dimension of the object in the axial direction and a volume varying with the dimension of the object in the axial direction.

The invention relates to a device for injection molding and overmolding objects, in particular for the production of laminated cores coated with an insulating layer. The device includes an upper element and a lower element which enclose a contiguous volume of a filling space for accommodating the object and casting material and a sprue for accommodating casting material. The upper element is movable relative to the lower element.

Cores of stators and rotors for electric motors known from the prior art are formed of packetized sheet metal layers, which are as thinly coated as possible, in particular encapsulated or overmolded or painted. The coating serves as an insulating layer for the wires wound around the cores in the form of coils.

The laminated cores composed of the stacked sheet metal layers have different outer dimensions due to the different thicknesses of the metal layers. The tolerance of the height or the thickness of the laminated packets results from the tolerance of the individual metal layers or the tolerances of the individual layers and the manufacturing process of the metal layers and the laminated cores.

In the production of conventional laminated cores, the sheet metal layers are punched and stamped together to form the laminated cores. During manufacture, the thickness of the laminated core is measured and a decision is then made with respect to the number of individual layers required for compliance with the desired total thickness.

The dissimilar outer dimensions of the different laminated cores occurring due to the large area and the large tolerance of the height of the laminated cores must be compensated during overmolding in an injection mold.

EP 0 507 211 A1 discloses a device for producing a core of an electrical coil which is provided with an insulating layer and formed by a laminated core. The device has an injection molding tool with an injection mold composed of a first part and a second part which is movable relative to the first part, wherein both parts bear against the core, forming a cavity which can be filled with an injection molding compound. The second movable part has a rigid mold part which together with the first part closes the injection mold and a spring-mounted part which rests on the core by way of projections having a small contact surface. The core bears against raised portions of the first part of the injection mold.

With this device, constant insulation layer thicknesses are produced during overmolding the core despite the different thicknesses of the core in the stacking direction of the sheets. The cavity, which is filled by injection molding compound, has always the same size relative to the surface. The different outer dimensions of the cores are compensated in the device by a variable and varying volume.

Prior art injection molding devices are unable to compensate for such large deviations in the outer dimensions of the laminated cores in an injection mold having a constant or variable internal volume by metering the filling quantity. Especially in multi-cavity molds, i.e. in molds constructed for the simultaneous overmolding several laminated cores of different thickness, not all cavities to be filled can be filled optimally, especially with plastic.

In conventional injection molding devices having a variable internal volume, the varying dimensions of the laminated cores can only be compensated by also varying the dimensions of the coated laminated core, so that the laminated cores have different outside dimensions for the same insulating layer thicknesses after coating.

With conventional devices for injection molding having a constant internal volume and in particular a constant amount of casting material, the cavities are filled unequally if the dimensions of the laminated cores vary. Adapting the amount of casting material to the particular dimensions of the laminated core makes the manufacturing process very complex and expensive.

A non-optimal or even unfavorable filling causes either the cavity to be overloaded or an unacceptable low compaction of the material for coating the laminated core. The inadequate filling also has a major impact on the dimensional accuracy of the parts and leads to excessively large dimensional deviations especially with geometries having demanding tolerance requirements, and thus to rejects.

It is the object of the invention to provide a device for injection molding and overmolding objects, in particular of laminated cores, wherein the coated laminated cores should have the same dimensions despite deviating outer dimensions of the laminated cores after coating and are thus able to meet stringent demands on the dimensional accuracy. The coating of the laminated cores should also be done with relatively small material consumption. The device should be structurally simple and should be producible and serviceable with minimal costs. The operation of the device and thus the manufacturing process of the overmolding the objects with the device should be economical, that is to entail minimal costs.

The object is achieved by the object with the features of the independent patent claim. Further developments are recited in the dependent claims.

The object is attained with an inventive device for injection molding and overmolding objects, in particular for the production of laminated cores coated with an insulating layer. The device includes an upper element and a lower element, which together enclose a contiguous volume composed of a filling space for accommodating the object and casting material and a sprue for accommodating casting material. The upper element is hereby movable with respect to the lower element.

When specifying the different volumes, a distinction must be made between the total internal volume of the injection molding device, in particular of the injection mold, with the contiguous volume of the filling space for accommodating the object to be coated plus the volume of the coating around the object, and the volume of the sprue. The volume of the coating of the object and the volume of the sprue are filled with casting material.

According to the concept of the invention, a piston adapted to move with respect to the upper element is integrated within the upper element. The position of the piston is hereby variable depending on a dimension of the object in an axial direction, and the piston has a protrusion for changing a volume as fill volume compensation of the casting material within the sprue, so that the device is filled with a constant amount of casting material regardless of the dimension of the object in the axial direction and a volume varying with the dimension of the object in the axial direction.

The volume that varies with the dimension of the object in the axial direction is hereby equal to the volume that can be changed with the protrusion of the piston as the fill volume compensation of the casting material within the sprue. The sprue for the uptake of casting material as a so-called material overflow is hence used as a fill volume compensation. The volume of the material overflow is adapted to the volume of the object or body to be coated whose dimension varies in particular in the axial direction, such that the same amount of casting material is always filled into the contiguous volume composed of the filling space and sprue minus the volume of the object as a cavity. The fill volume compensation is thus shifted to the partial volume of the sprue. The control of the fill quantity compensation or the volume compensation, respectively, is coupled to the dimension of the object in the axial direction, in particular to the height or the thickness of the laminated core.

The outer dimensions of the different laminated cores which deviate from one another due to the large area and the large height tolerance of the laminated cores are compensated in the device as an injection mold having a constant internal volume by way of different fill quantities of the casting material inside the filling space as a material for coating the laminated cores, in particular plastic.

The sprue is to be understood as the part of the injection-molded part, in particular when injection-molding plastic or metal, which is not attributable to the actual molded part and is formed by the melt solidified in the feed channels to the mold.

According to a preferred embodiment of the invention, the upper element of the device is constructed in two parts, with a first component and a second component divided at a parting plane. Advantageously, the first component of the upper element has a formation for inserting the piston.

According to a further embodiment of the invention, a gap as a region of the sprue is formed in a region of the parting plane between the first component and the second component of the upper element of the device. The gap forming the region of the sprue is also to be understood as a partial volume of the sprue.

Preferably, the piston has a portion with a smaller thickness and a portion with a greater thickness, which are arranged coaxially with each other in the axial direction. The section with the greater thickness is hereby designed as a protrusion for changing the volume as a fill volume compensation of the casting material within the sprue. The portion with the smaller thickness is disposed at the circumference of the portion with the larger thickness.

According to an advantageous embodiment of the invention, the protrusion of the piston for changing the volume as a fill volume compensation for the casting material within the sprue is constructed as a through-opening extending in the axial direction in the first component of the upper element of the device and protruding into the gap formed between the first component and the second component as a partial volume of the sprue. The partial volume of the sprue is also referred to as the sprue region.

According to a further embodiment of the invention, the piston has at least one pin of constant length, which is aligned in the axial direction and arranged in the region of the portion of the piston with the smaller thickness. Advantageously, the at least one pin of the piston movably extends through a through-opening formed in the upper element and projects into the filling space for receiving the object.

According to a further preferred embodiment of the invention, an end face of the at least one pin of the piston bears against a top side of the object arranged in the filling space and protrudes into the filling space in the axial direction, depending on the dimension of the object arranged within the filling space.

The movement or the arrangement of the pin, when the device is closed, and thus the movement and arrangement of the piston and also of the protrusion of the piston in the axial direction depend on the dimension of the object disposed within the filling space in the axial direction. The length with which the pin of the piston protrudes into the filling space is directly proportional to the length with which the piston protrudes into the volume of the sprue as immersion depth.

Advantageously, the piston has a plurality of pins, in particular three or four pins, each with a constant length, which are arranged in the region of the portion with the smaller thickness circumferentially around the protrusion of the piston in the axial direction.

According to a further preferred embodiment of the invention, the filling space is formed as a formation for inserting the object in the lower element of the device. The lower element has hereby advantageously at least one fixed abutment.

The at least one fixed abutment is preferably formed as a cylindrical bolt, which extends into the filling space and is arranged such that the object bears with a bottom side against an end face of the bolt. The bolt is immovably inserted into the lower element by way of a through-opening formed in the bottom of the lower element.

Advantageously, the lower element has a plurality of abutments, in particular three or four abutments, which are arranged circumferentially and aligned in the axial direction.

According to a further embodiment of the invention, the object to be coated is rotationally symmetrical. Thus, the filling space, the piston and the sprue, the upper element and the lower element and consequently also the device are preferably rotationally symmetrical.

In summary, the device according to the invention for injection molding and overmolding objects has various advantages:

Compensation of large deviations of external dimensions of objects to be coated, in particular of laminated cores, by metering the filling amount within the filling space in a device having variable internal volume while having a constant volume for the casting material to be filled, whereby coated objects are produced that, in particular, have identical dimensions in the axial direction while the objects to be coated have varying dimensions in the axial direction,
thin-walled coating of packetized sheet metal layers is possible,
use of an always constant amount of casting material, in particular of plastic, when filling the device, wherein the volume compensation or fill volume compensation according to the invention ensures that the volume for each cavity to be filled is constant even for variable dimensions of the object to be coated, thereby
coupling the control of the volume compensation to the dimension of the object in the axial direction, in particular to the height of the object,
optimum filling without overloading the filling space or the cavity, respectively, with optimal compaction of the material for coating the object, and
very high dimensional accuracy even with geometries having very stringent tolerance requirements.

Further details, features and advantages of embodiments of the invention will become apparent from the following description of an exemplary embodiment with reference to the appended drawings, which show in:

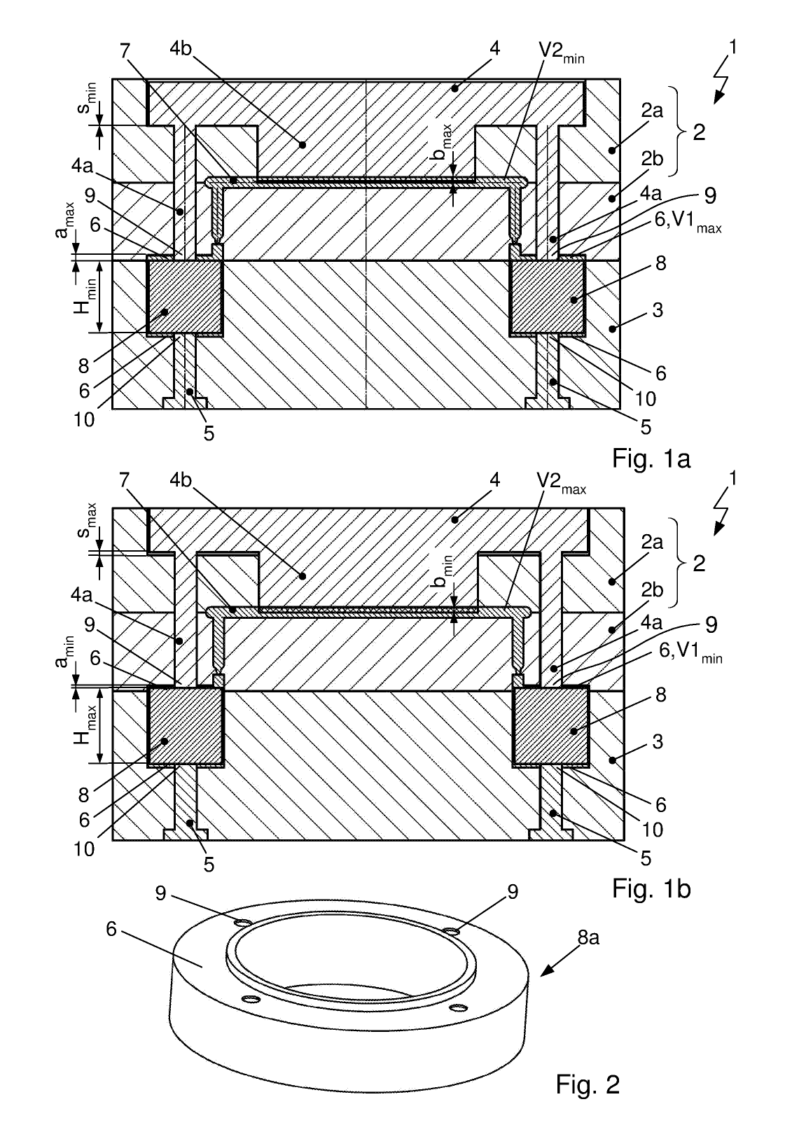

FIG. 1 a device for injection molding and overmolding objects, in particular laminated cores with different outer dimensions, with a laminated core arranged in the device,

FIG. 1a with a laminated core having minimum height arranged in the device,

FIG. 1b with a laminated core having maximum height arranged in the device, and

FIG. 2a coated laminated core having a rotationally symmetrical shape.

FIGS. 1a and 1b each show a device 1 for injection molding and overmolding objects 8, in particular of laminated cores having different external dimensions, with a laminated core 8 with minimum height being arranged in the device 1, as shown in FIG. 1a, and with a laminated core 8 with maximum height, as shown in FIG. 1b. The deviating outer dimensions of the laminated cores 8, in particular the height, result especially from different thicknesses of the stacked sheet metal layers.

The larger tolerances of the dimensions of the sheet metal layers and thus of the laminated core 8 occur predominantly in the height, i.e. in the stacking direction of the sheet metal layers. In the other directions, the tolerances influencing the outer dimensions of the laminated core 8 are negligible, since these dimensions can be very precisely specified by tools, such as stamping dies. The device 1 is thus designed such that the deviations in the height of the object 8 to be coated are compensated, whereas no additional measures for compensation of tolerances are provided in the other geometrical dimensions in addition to the usual measures.

The device 1 has as an injection molding tool a mold with an upper element 2 and a lower element 3. The upper element 2 is movable with respect to the stationary lower element 3. The upper element 2 is furthermore formed in two parts with a first component 2a and a second component 2b.

The lower element 3 of the mold is provided with a formation for inserting the object 8 to be coated and with fixed abutments 5. The formation has hereby the outer dimensions of the object 8 plus a volume for coating all sides. The volume and thus the individual dimensions of the coating in different geometrical dimensions correspond in each case to the thickness of the coating, in particular of the insulating layer of the laminated core 8.

The fixed abutments 5 are formed as pins or bolts and are immovably and rigidly inserted into the lower element 3 through through-openings formed in the bottom of the lower element 3 and extend from the bottom through the through-openings up to the formation for accommodating the object 8 to be coated. The bolts are each formed with a collar which locks the bolt in the lower element 3 as a stop. The collar of the bolt and the bottom of the lower element 3 are arranged flush in the mounted state of the device 1.

The object 8 is inserted in the formation of the lower element 3 for overmolding, wherein the object 8 bears with a bottom side of the end faces against support areas 10 of the abutment 5 projecting into the formation, such that the object 8 is uniformly spaced from a bottom of the formation. A gap for pouring, for example a plastic material, remains between the bottom side of the object 8 and the bottom of the formation, wherein the size of the spacing and thus the width of the gap are independent of the dimensions of the different laminated cores 8.

In addition, the side faces of the object 8 and the formation are spaced from each other, each forming a gap. The spacings and contiguous gaps between the bottom side of the object 8 and the bottom of the formation and between the side faces of the object 8 and the formation define regions of the filling space 6 and the subsequently applied coating of the object 8, respectively.

The lower element 3 and the upper element 2 of the mold are separated from each other in a parting plane. The upper element 2 formed of the first component 2a and the second component 2b is movable in the direction perpendicular to the parting plane.

A movable piston 4, which is formed with pins 4a and a protrusion 4b for fill volume compensation, is integrated within the upper element 2. The pins 4a and the protrusion 4b of the piston 4 are also referred to as piston mechanism. The piston 4 is movable within and with respect to the upper element 2 of the mold.

The first component 2a of the upper element 2 is provided with a formation for inserting the piston 4. The formation has the outer dimensions of the piston 4 plus a tolerance for movement of the piston 4. Advantageously, the piston is cylindrical, in particular circular cylindrical.

The piston 4 is formed with a portion having a smaller thickness and a portion having a greater thickness, wherein the portions are arranged coaxially or concentrically with respect to each other and an end face of the piston 4 is flat. The flat end face closes the device 1 to the outside.

The portion with the greater thickness extends in the axial direction through a through-opening formed in the first component 2a, serves as a protrusion 4b for filling quantity compensation and protrudes in the closed state of the device 1 into a gap formed between the first component 2a and the second component 2b. The through-opening is arranged as a connection between the formation for insertion of the piston 4 and the gap.

The gap is oriented substantially in the direction of the parting plane and is connected via openings formed in the second component 2b with the filling space 6 that contains the object 8 inserted in the device 1. The gap and the openings connecting the gap with the filling space 6 are regions of the sprue 7 of the mold and serve as an additional filling volume for accommodating an excess filling quantity of the casting material.

The pins 4a of the piston 4 are arranged circumferentially in the region of the portion having the smaller thickness of the piston 4 and are thus also arranged circumferentially around the protrusion 4b at the same distance from the axis of symmetry and in the axial direction of the piston 4. The pins 4a are movably inserted into the upper element 2 through through-openings extending through the first component 2a and the second component 2b of the upper element 2 and extend from the portion with the smaller thickness of the piston 4 through the through-openings to the formation for accommodating the object 8 to be overmolded. The through-openings formed in the first component 2a and in the second component 2b correspond to each other such that one through-opening through the upper element 2 is provided for each pin 4a.

In the closed state of the device 1, the end faces of the pins 4a bear against a top side of the object 8 inserted in the formation of the lower element 3 for overmolding in contact areas 9. The second component 2b of the upper element 2 of the mold has in the region of the parting plane between the upper element 2 and the lower element 3 a recess corresponding to the formation in the lower element 3 for receiving the object 8. The recess of the upper element 2 and the formation of the lower element 3 together form the filling space 6 as a volume for accommodating the object 8 and the casting material as a coating of the object 8.

The pins 4a protrude into the recess, when the end faces bear against the top of the object 8. A uniform spacing, i.e. a gap a for pouring, for example a plastic material, is formed between the top side of the object 8 and the recess, wherein the size of the spacing and thus the width a of the gap depend on the dimensions of the different laminated cores 8, in particular the height of the object 8.

The distances and the contiguous gaps between the bottom of the object 8 and the bottom of the formation of the lower element 3 of the mold and between the side faces of the object 8 and the formation of the lower element 3 of the mold as well as between the top of the object 8 and the recess of the second component 2b of the upper element 2 of the mold enclose regions of the filling space 6 or of the subsequently applied coating of the object 8, respectively. The filling space 6 is connected to the sprue 7.

FIGS. 1a and 1b each show the device in the closed state with inserted laminated core 8, filled casting material and mounted piston 4. The piston 4 is arranged in FIG. 1a at the bottom dead center and in FIG. 1b at the top dead center. The dead centers refer to the respective minimum or maximum possible end positions of the piston 4 that result from the thickness of the laminated core 8 when exhausting the entire possible tolerance. When the laminated core 8a has a minimum possible thickness, the piston 4 is at the bottom dead center, whereas the piston 4 is at the top dead center when the laminated core 8 has a maximum possible thickness.

The upper element of the mold together with the piston 4 can be moved vertically up or down as a unit in the axial direction by way of an unillustrated drive, to ensure insertion of the object 8. The device 1 is closed by moving the upper element 2, in particular the second component 2b and thereafter the first component 2a or by concurrently moving the components 2a, 2b with the piston 4 downward.

The object 8 to be coated, in particular the laminated core 8 to which an insulating layer is to be applied, is in the open state of the device 1 inserted with the bottom side in the formation of the lower element 3 on the end faces of the bolt-shaped abutment 5. When the device 1 is closed, the formation with the object 8 now inserted therein is also closed, wherein the formation of the lower element 3 and the recess of the upper element 2 form a closed volume, which also includes the sprue 7. The object 8 to be coated is thus arranged in the device 1 so that a gap for pouring the casting material remains between the object 8 and the device 1 along the entire circumference and over the entire surface. The object 8 bears against the components of the device 1 only in the support areas 9 of the pins 4a and the contact areas 10 of the abutment 5.

When closing the device 1, the end faces of the axially movable pins 4a of the piston 4 bear against the top side of the object 8. The piston 4 is hereby moved in the axial direction with respect to the upper element 2 within the upper element 2, depending on the height dimension of the object 8, which is aligned with the axial direction. After the device 1 is fully closed, the piston 4 has reached its end position and is mechanically locked against the injection pressure.

When the object 8 has a minimum height dimension Hₘᵢₙ, as shown in FIG. 1a, the piston 4 is only minimally deflected when at the position at the bottom dead center. The distance s between the piston 4, in particular the portion with the smaller thickness, and the first component 2a of the upper element 2 is minimal with sₘᵢₙ and may be zero in a limiting case. The piston 4 then bears against the first component 2a of the upper element 2.

While the gap between the bottom side of the object 8 and the bottom of the formation of the lower element 3 of the mold and between the side faces of the object 8 and the formation of the lower element 3 of the mold regardless of object 8, are constant aside from negligible variations in the width of the object 8, the gap a between the top side of the object 8 and the recess of the second component 2b of the upper element 2 of the mold has a maximum aₘₐₓ. The gap a encloses a maximum volume V1ₘₐₓ. The volume V1 enclosed by the gap a is dependent on the height dimension H of the object 8. In addition, the protrusion 4b of the piston 4 projects into the volume V2 of the sprue 7 with a maximum insertion depth. The piston 4 displaces with the portion of protrusion 4b immersed in the volume V2 of the sprue 7 a maximum volume of the sprue 7 as an excess of the filling volume, so that the sprue 7 has only a minimum volume V2ₘᵢₙ for the casting material. Since the total volume of the device 1 for the casting material, i.e. the filling space 6 minus the volume of the object 8 and the volume V2 of the sprue are constant, the volume V1 of the gap a and the volume of the sprue 7 displaced by protrusion 4b of the piston 4, respectively, are inversely proportional to the volume V2 of the sprue 7.

For a maximum height dimension Hₘₐₓ of the object 8 shown in FIG. 1b, the piston 4 is maximally deflected in the position at the top dead center due to the pins 4a having a constant length. The distance s between the piston 4 and the first component 2a of the upper element 2, in particular the portion with the smaller thickness, is a maximum with sₘₐₓ.

In addition, the gap a between the top side of the object 8 and the recess of the second component 2b of the upper element 2 of the mold has a minimum aₘᵢₙ, since the height of the filling space 6 of the device 1, i.e. the height of the formation formed in the lower element 3 and of the recess formed in the upper element 2 volume is constant. The gap a hereby encloses a minimum volume V1ₘᵢₙ, since the height dimension H of the object 8 is a maximum with Hₘₐₓ.

The protrusion 4b of the piston 4 protrudes only minimally into the volume V2 of the sprue 7, so that the immersion depth b of the protrusion 4b into the volume V2 of the sprue 7 is minimal. The piston 4 thus displaces only a minimal volume of the sprue 7 with the portion of the protrusion 4b being immersed in the volume V2 of the sprue 7, so that the sprue 7 has a maximum volume V2ₘₐₓ for the casting material.

Consequently, the gap a and thus the volume V1 change as a subregion of the filling space 6 as a function of the height dimension H of the object 8, wherein the volume V1 varies due to the change of the gap a. With the design of the piston 4, the immersion depth b of the protrusion 4b into the volume V2 of the sprue 7 as a subregion of the total volume of the casting material also changes commensurate with the change in the dimension H of the object 8. The volumes V1 of the gap a as a subregion of the filling space 6 and of V2 of the sprue 7 in each case as subregions of the total volume of the casting material change in opposite directions and hence have always the same magnitude.

Since the volumes V1 and V2 each represent subregions of the total volume of the casting material and since the volume V2 decreases in the same amount as the volume V1 increases and likewise the volume V2 increases in the same amount as the volume V1 decreases, the entire volume of the casting material remains constant within the device 1 independent of the height dimension of the object 8.

Depending on the height dimension of the object 8, the casting material is introduced in the volume V1 or displaced as volume V2 into the sprue 7. The filling quantity remains unchanged with respect to the total volume to be filled with casting material for any dimension of the object 8 in the direction of the height H. Only the distribution of the filling quantities within the device 1, in particular within the filling space 6, and thus the coating as an outer coating of the object 8 are different.

The coating is also formed so as to be fully closed along the entire circumference and over the entire surface, with only a few areas of the rotationally symmetrical, coated object 8a having no coating at all, as is apparent from FIG. 2.

The contact areas 9 of the pins 4a of the piston 4 on the top side of the object 8a and the unillustrated contact areas 10 of the bolt-shaped abutments 5 on the bottom side of the object 8a are not covered by a coating and can be reworked or be used, for example, for the placement of connections

### LIST OF REFERENCE SYMBOLS

1 device
2 upper element mold
2a first component upper element 2
2b second component upper element 2
3 lower element mold
4 movable piston upper element 2
4a pin piston 4 upper element 2
4b protrusion piston 4 for fill volume compensation
5 abutment
6 filling space
7 sprue
8 object, laminated core
8a coated object 8
9 contact area pin 4a object 8
10 contact area abutment 5 object 8
a spacing
b immersion depth protrusion 4b
H height of the object, laminated core 8
s deflection
V1 variable volume laminated core 8
V2 variable volume sprue
max maximal
min minimal

What is claimed is:

1-10. (canceled)

11. A device for injection molding and overmolding objects, said device comprising:
an upper element and a lower element, said upper and lower elements together enclosing a contiguous volume formed of a filling space for accommodating the object and casting material and a sprue for accommodating casting material, said upper element being movable with respect to the lower element; and
a piston integrated within the upper element and movable with respect to the upper element, wherein a position of the piston is variable depending on a dimension of the object in an axial direction, said piston having a protrusion for changing a volume of the casting material within the sprue as a fill volume compensation, such that the device is filled with a constant amount of casting material independent of the dimension of the object in the axial direction and independent of a volume varying with the dimension of the object in the axial direction.

12. The device of claim 11, for producing laminated cores coated with an insulating layer.

13. The device of claim 11, wherein the upper element is divided at a parting plane into a first component and a second component, said first component having a formation for insertion of the piston.

14. The device of claim 13, wherein in a region of the parting plane between the first component and the second component, a gap is formed as a region of the sprue.

15. The device of claim 11, wherein the piston has a first section with a smaller thickness and a second section with a greater thickness, said first and second sections being arranged coaxially with respect to each other in the axial direction, wherein the section with the greater thickness is designed as a protrusion for changing the volume of the casting material as a fill volume compensation within the sprue, and the section with the smaller thickness is arranged along a circumference of the section with the greater thickness.

16. The device of claim 15, wherein the protrusion of the piston is arranged so as to protrude in the axial direction through a through-opening formed in the first component of the upper element and into the gap formed between the first component and the second component as a partial volume of the sprue.

17. The device of claim 11, wherein the piston comprises at least one pin having a constant length, said at least one pin being arranged in the region of the section with the smaller thickness of the piston in alignment with the axial direction.

18. The device according to claim 17, wherein the at least one pin of the piston is movably arranged and extends through a through-opening formed in the upper element and protrudes into the filling space for accommodating the object.

19. The device of claim 18, wherein an end face of the at least one pin bears against a top side of the object arranged in the filling space and protrudes into the filling space in the axial direction depending on the dimension of the object arranged inside the filling space.

20. The device of claim 11, wherein the filling space is designed as a formation for insertion of the object in the lower element, and the lower element has at least one fixed abutment.

21. The device of claim 20, wherein the at least one fixed abutment is designed as a cylindrical bolt, which is arranged so as to extend into the filling space such that the object bears with a bottom side against an end face of the bolt.

22. A method for producing laminated cores coated with an insulating layer with the device of claim 11, said method comprising the steps of:
inserting an object into a formation of the lower element in an open state of the device, so that a bottom side of the object is evenly spaced apart from a bottom of the formation by a gap, and side surfaces of the object and of the formation are spaced apart from each other by a respective gap, said gap between the bottom side of the object and the bottom of the formation and the resective gap between the side surfaces of the object and of the the formation defining contiguous regions of a filling space;
closing the device by moving the upper element and the piston perpendicularly downward in axial direction,
wherein the formation of the lower element with the object inserted therein is closed so that the formation and a recess of the upper element and the sprue form a closed volume, and wherein a gap for overmolding remains between an entire surface and entire circumference of the object and the device, and
wherein the piston is moved in axial direction within the upper element with respect to the upper element depending on the dimension of the object in axial direction;
locking the piston; and
filling the filling space of the device with a casting material, wherein depending on the dimension of the object in the axial direction a portion of the casting material is introduced into the volume which varies in axial direction with the dimension of the object or is displaced into the sprue.

23. The method of claim 22, wherein the volume, which varies in the axial direction and the volume of the sprue are changed inversely as partial regions of an entire volume of the casting material depending on the dimension of the object in axial direction and the entire volume of the casting material always has the same value independent of the extent of the object in axial direction.

24. The method of claim 22, wherein during closing of the device pins of the piston which are movable in axial direction, bear against a top side of the object arranged in the filling space.

25. The method of claim 22, wherein during insertion of the object into the formation of the lower element a bottom side of the object is placed in support regions onto end faces of abutments which protrude into the formation.

26. The method of claim 22, wherein during the closing of the device the upper element is moved together with the piston as a unit.
